(19) United States
(12) Patent Application Publication
(10) Pub. No.: US 2024/0334990 A1
(43) Pub. Date: Oct. 10, 2024

(54) CUP WITH HOLLOW LOWER BOWL AND ONE-PIECE CUP WITH HOLLOW LOWER BOWL

(71) Applicant: KAIPING U-LIKE UNDERGARMENT ACCESSORIES CO., LTD., Jiangmen (CN)

(72) Inventor: Suilong ZHANG, Jiangmen (CN)

(21) Appl. No.: 18/743,223

(22) Filed: Jun. 14, 2024

Related U.S. Application Data
(63) Continuation of application No. PCT/CN2022/097734, filed on Jun. 8, 2022.

(30) Foreign Application Priority Data
Dec. 16, 2021 (CN) 202123196746.9

(51) Int. Cl. A41C 3/00; B32B 3/30; B32B 5/02; B32B 5/18; B32B 5/24; B32B 5/32; B32B 27/06; B32B 27/12; B32B 27/30; B32B 27/40

(52) U.S. Cl. CPC A41C 3/0014; A41C 3/0085; B32B 3/30; B32B 5/028; B32B 5/18; B32B 5/245; B32B 5/32; B32B 27/065; B32B 27/12; B32B 27/306; B32B 27/40; B32B 2250/05; B32B 2274/00; B32B 2437/00

(57) ABSTRACT

A cup with hollow lower bowl includes a cup body, the cup body is divided into an upper bowl and a lower bowl integrally formed with the upper bowl, a cradle extends from the lower bowl, and a plurality of ventilation notches are defined at intervals at a joint of the lower bowl and the cradle. A one-piece cup with hollow lower bowl includes a connection portion and two sub-cups with hollow lower bowl, the two sub-cups with hollow lower bowl are symmetrically arranged and are integrally formed with the connection portion, and each of the two sub-cups with hollow lower bowl is configured as the above cup with hollow lower bowl.

### CROSS-REFERENCE TO RELATED APPLICATION

This application is a continuation of PCT application serial no. PCT/CN2022/097734, filed on Jun. 8, 2022, which claims the priority and benefit of Chinese patent application serial no. 202123196746.9, filed on Dec. 16, 2021. The entireties of PCT application serial no. PCT/CN2022/097734 and Chinese patent application serial no. 202123196746.9 are hereby incorporated by reference herein and made a part of this specification.

### FILED OF THE INVENTION

The present application relates to the field of female underwear technologies, and in particular, to a cup with hollow lower bowl and a one-piece cup with hollow lower bowl.

### BACKGROUND OF THE INVENTION

A brassiere is one of indispensable articles for use in the daily life of women. With the development of the technology, more and more kinds of brassieres are developed, such as a brassiere with good air permeability, a brassiere comfortable to wear, an antibiotic brassiere, or the like, to meet different demands of women.

The brassiere is generally formed by connecting cups and a shoulder strap, the cup is the most important part of the brassiere, and whether a woman may comfortably wear the brassiere largely depends on fit of the cup and the breast. By the brassiere produced by the cups on the current market, when the arm of the woman is lifted up, movement of the shoulder may cause movement of the shoulder strap, and the shoulder strap bears an upward force, so as to move the cup upwards, which leads to cup displacement, such that the cup does not fit the breast any more, resulting in an uncomfortable wearing.

### SUMMARY

The present application provides a cup with hollow lower bowl, so as to solve the problem of cup displacement of a brassiere when a woman lifts her hand.

In a first aspect, the present application provides a cup with hollow lower bowl, which adopts the following technical solution.

A cup with hollow lower bowl includes a cup body, the cup body is divided into an upper bowl and a lower bowl integrally formed with the upper bowl, a cradle extends from the lower bowl, and a plurality of ventilation notches are defined at intervals at a joint of the lower bowl and the cradle.

When the arm of a woman is lifted up, the cup slides upwards under a dragging action of a shoulder strap and does not fit the breast, and when the arm of the woman is withdrawn downwards, the cup cannot return to a proper position, to completely fit the breast and press the breast. In order to reset the cup, the cup is required to be adjusted, which is troublesome. Therefore, in the present application, a buffer zone is formed by providing the plurality of ventilation notches at intervals at the joint of the lower bowl and the cradle, such that the cup may completely fit the breast when the woman lifts the arm up, thereby reducing cup displacement. When the arm is lifted up, the shoulder strap drives the upper bowl and the lower bowl to move upwards, the ventilation notch is deformed to form the buffer zone. Since the buffer zone separates the lower bowl from the cradle, a dragging force applied by the lower bowl to the cradle is smaller than a contact friction force of the cradle and the breast, such that the cradle may stably fit the breast, thereby effectively reducing the cup displacement. Meanwhile, the capacity of a cup body can be expanded to cover one size more, thereby improving a wearing comfort. In addition, the ventilation notch may improve air permeability of the cup, such that the breast may be kept in a dry and comfortable state, and the practicability is high.

Optionally, each of the plurality of ventilation notches has a width of 4-10 mm.

If the width of the ventilation notch is less than 4 mm, the area of the buffer zone formed by the ventilation notch is small when the arm is lifted up, such that the dragging force applied by the lower bowl to the cradle is greater than the contact friction force of the cradle and the breast. When the hand is lifted up, the cradle moves upwards, such that a cup displacement is prone to be caused. If the width of the ventilation notch is greater than 10 mm, the area of the buffer zone formed by the ventilation notch is large when the arm is lifted up, such that the dragging force applied by the lower bowl to the cradle is smaller than the contact friction force of the cradle and the breast, the ventilation notch is difficult to reset, which is not conducive to the fit of the cup and the breast, such that the brassiere is uncomfortable to wear.

Optionally, each of the plurality of ventilation notches is arc-shaped, intermittent arc-shaped, zigzag, waved or rhombic.

By adopting the technical solution, the area of the buffer zone formed by the ventilation notch is large, such that the shape of the area of the buffer zone may be flexibly changed. When the hand is lifted up in any direction, the shape of the buffer zone can be changed with the change of the arm direction, thus reducing the cup displacement. Meanwhile, the air permeability of the cup is increased, sweat may be discharged conveniently, bacterium breeding in the cup is reduced, and the cup is kept clean, dry and comfortable, thereby improving the wearing comfort.

Optionally, each of the upper bowl, the lower bowl and the cradle sequentially includes a composite layer and a first cloth layer from outside to inside, the composite layer is bonded to the first cloth layer, a side of the composite layer away from the first cloth layer is in contact with an outerwear, a side of the first cloth layer away from the composite layer is in contact with a breast, and the plurality of ventilation notches are defined in the composite layer and penetrate through the composite layer.

By adopting the technical solution, the cup is light and thin and has good air permeability. When the ventilation notch is deformed, the first cloth layer fits the breast, such that the cup may stably fit the breast during the movement of the hand, thereby reducing the cup displacement. The first cloth layer is connected with the composite layer, and the first cloth layer applies a dragging force to the composite layer, such that the deformed ventilation notch recovers rapidly, thus the cup may more stably fit the breast.

Optionally, the first cloth layer is an elastic cloth layer.

By adopting the technical solution, the cup is not prone to deformation during dragging. The elastic cloth has good elasticity. The elastic cloth is driven by the shoulder strap to be deformed when the hand is lifted up, meanwhile the ventilation notch is also deformed, such that the cradle may stably contact the breast, so as to avoid the cup displacement, and a recovering effect may be rapidly achieved after being dragged, to maintain the shape of the cup.

Optionally, the composite layer sequentially includes a second cloth layer, a first sponge layer and a second sponge layer, the first sponge layer is connected with the second cloth layer, and the second sponge layer is connected with the first cloth layer.

By adopting the technical solution, the cup is thin, whose performances, such as ventilation, the comfort, softness, or the like, are improved, and the sponge layer has a porous structure, thus facilitating sweat absorption and moisture elimination, so as to reduce a stuffy feeling.

Optionally, the composite layer further includes a formed net layer, and the formed net layer is provided between the first sponge layer and the second sponge layer.

The formed net has a hard texture and is not prone to deformation, such that the cup may be used for a long time without deformation. After the shaped net layer, the first sponge layer and the second sponge layer are pressed and shaped, the shaped net may support the first sponge layer and the second sponge layer for a long time because the first sponge layer and the second sponge layer have a soft texture and cannot be shaped, so as to keep the cup from deforming.

Optionally, a hot melt adhesive film for bonding is provided between the first cloth layer and the second sponge layer, and the hot melt adhesive film is one of a Thermoplastic Urethane (TPU) film, a Polyamide (PA) film and a Polyethylene vinylacetate (EVA) film.

By adopting the technical solution, the first cloth layer and the second sponge layer can be firmly bonded. The TPU film, the PA film and the EVA film have soft textures, good air permeability and good viscosity, and are resistant to washing. The cup which is thermally bonded by the TPU film, the PA film or the EVA film is not stuffy and has a good moisture elimination effect. In addition, after multiple times of washing, the first cloth layer and the second sponge layer may be stably connected.

In a second aspect, the present application provides a one-piece cup with hollow lower bowl, which adopts the following technical solution.

A one-piece cup with hollowed lower bowl includes a connection portion and two sub-cups with hollowed lower bowl, the two sub-cups with hollowed lower bowl are symmetrically arranged and are integrally formed with the connection portion, and each of the two sub-cups with hollowed lower bowl is configured as the cup with hollowed lower bowl according to the first aspect. By adopting the technical solution, the produced underwear has a ventilation effect, is not stuffy and has a good moisture elimination effect, additionally, the cup may completely fit the breast, thereby reducing cup displacement and further improving a wearing comfort.

In summary, the present application at least has the following beneficial effects.

1. In the present application, the buffer zone is formed by providing the plurality of ventilation notches at intervals at the joint of the lower bowl and the cradle, such that the cup may completely fit the breast when the woman lifts the arm up, thereby reducing the cup displacement.

2. Since the ventilation notch is arc-shaped, intermittent arc-shaped, zigzag, waved or rhombic, the area of the buffer zone formed by the ventilation notch is large, the shape of the area of the buffer zone may be more flexibly changed, such that when the hand is lifted up in any direction, the shape of the buffer zone may be changed with the change of the arm direction, thus reducing the cup displacement. Meanwhile, the air permeability of the cup is increased, such that sweat may be discharged conveniently, which reduces the bacterium breeding in the cup, to keep the cup clean, dry and comfortable, thereby improving the wearing comfort.

3. By the hollow one-piece cup according to the present application, the underwear has a ventilation effect, is not stuffy and has a good moisture elimination effect, and the cup may completely fit the breast, thereby reducing the cup displacement and further improving the wearing comfort.

### BRIEF DESCRIPTION OF THE DRAWINGS

FIG. 1 is a schematic front view of a cup with hollow lower bowl having an arc-shaped ventilation notch according to the first embodiment of the present application.

FIG. 2 is a schematic rear view of a cup with hollow lower bowl according to the first embodiment of the present application.

FIG. 3 is a schematic front view of a cup with hollow lower bowl having an intermittent arc-shaped ventilation notch according to the first embodiment of the present application.

FIG. 4 is a schematic front view of a cup with hollow lower bowl having a zigzag ventilation notch according to the first embodiment of the present application.

FIG. 5 is a schematic front view of a cup with hollow lower bowl having a waved ventilation notch according to the first embodiment of the present application.

FIG. 6 is a schematic front view of a cup with hollow lower bowl having a rhombic ventilation notch according to the first embodiment of the present application.

FIG. 7 is a schematic view showing the layer structure of a cup with hollow lower bowl according to the first embodiment of the present application.

FIG. 8 is a schematic view showing the surface structure of the one-piece cup with hollow lower bowl according to the second embodiment of the present application.

### DETAILED DESCRIPTION

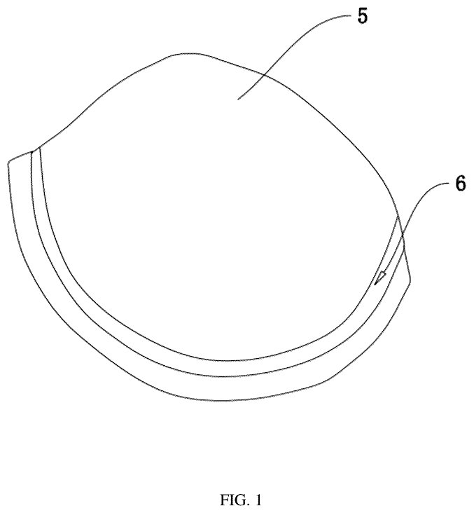

The present application is described in further detail below with reference to FIGS. 1 to 8.

### First Embodiment

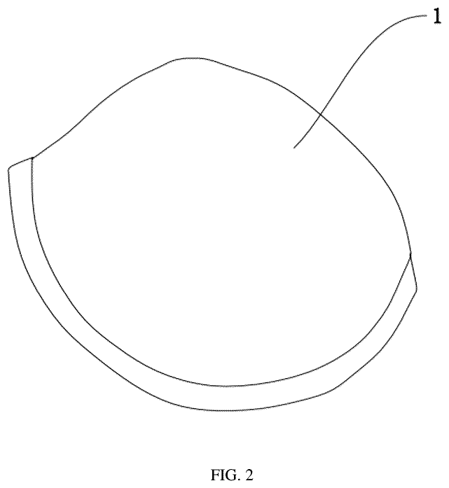

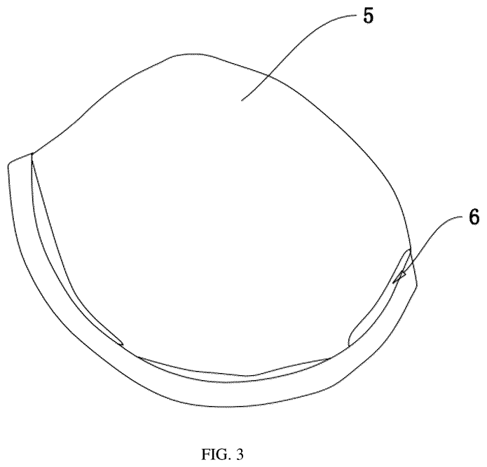

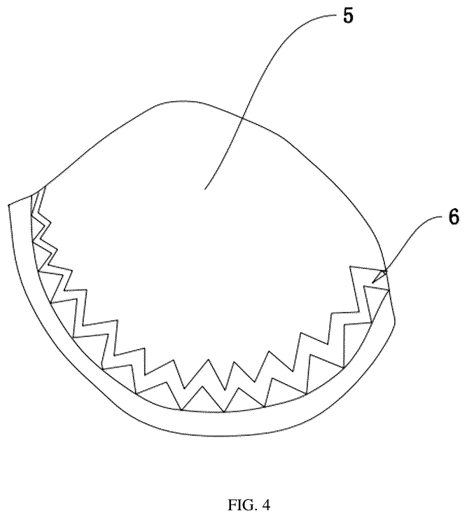

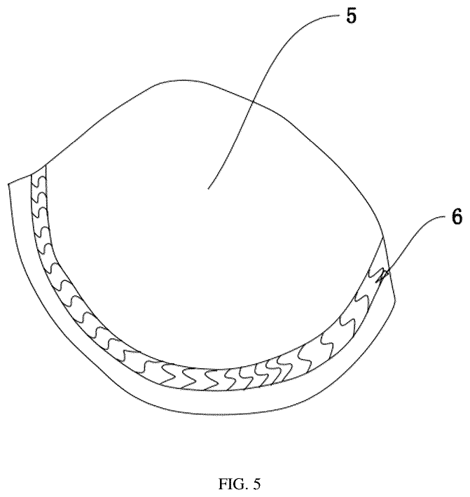

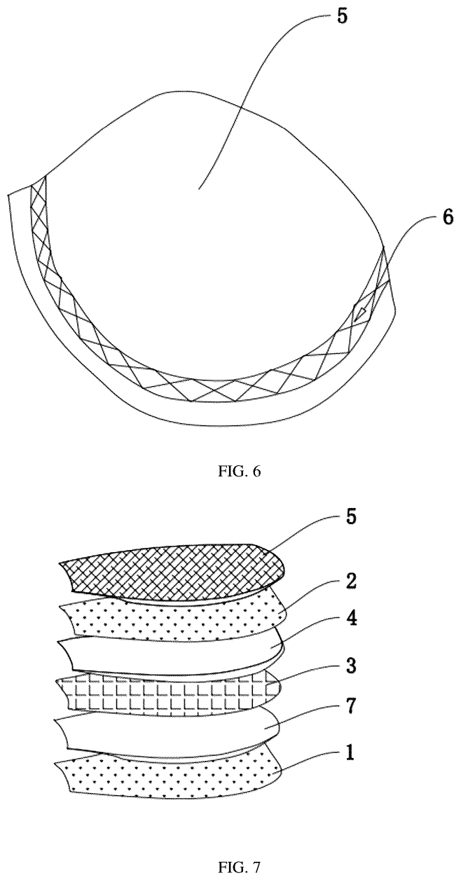

The embodiment of the present application discloses a cup with hollow lower bowl. Referring to FIGS. 1 and 2, the cup with hollow lower bowl sequentially includes an upper bowl, a lower bowl and a cradle from top to bottom, and the upper bowl, the lower bowl and the cradle are integrally formed. The joint of the lower bowl and the cradle is a curve, the curve is matched with the breast curve. The ventilation notch 6 is formed at intervals along the curve, the length of the ventilation notch 6 may change with the cup size or the cup type. The ventilation notch 6 is arc-shaped in the present embodiment, and in other embodiments, other shapes may be adopted. Referring to FIG. 3, FIG. 4, FIG. 5 or FIG. 6, the ventilation notch 6 may be intermittent arc-shaped, zigzag, waved or rhombic. In other embodiments, the ventilation notches 6 may be arranged at plural intervals, and the width of an arc of the ventilation notch 6 is 4 mm, 5 mm, 6 mm, 7 mm, 8 mm, 9 mm or 10 mm, so as to form a buffer zone, and the width of the ventilation notch 6 in the present embodiment is 4 mm.

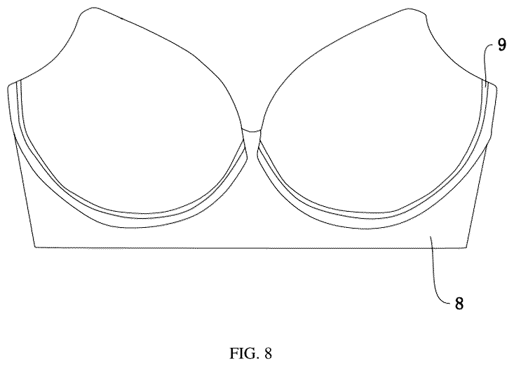

Referring to FIG. 7, each of the upper bowl, the lower bowl and the cradle sequentially includes a composite layer in contact with the outerwear and the first cloth layer 1 in contact with the breast from outside to inside, the first cloth layer 1 is an elastic cloth layer, the composite layer and the first cloth layer 1 are integrally bonded by pressing. The cradle bears a relative higher pressure when in use, thus a relative higher pressure force shall be applied to it, such that the cradle has a hard texture, so as to support the upper bowl and the lower bowl. The lower bowl and the upper bowl bear a relative smaller pressure, thus a relative smaller pressure may be applied to them, such that the upper bowl and the lower bowl have soft textures, so as to fit the breast and possess a good air permeability. Returning back to FIG. 1, the ventilation notch 6 is defined at the joint of the cradle and the lower bowl and penetrates through the composite layer.

The composite layer includes the second cloth layer 5 in contact with the outerwear, the first sponge layer 2 connected with the second cloth layer 5, a formed net layer 4 connected with the first sponge layer 2, and the second sponge layer 3 connected with the formed net layer 4. The second sponge layer 3 is connected with the first cloth layer 1, and the first cloth layer 1, the second sponge layer 3, the formed net layer 4, the first sponge layer 2 and the second cloth layer 5 are integrally formed by pressing. The formed net layer 4 is located in the lower bowl. A hot melt adhesive film layer 7 is provided between the second sponge layer 3 and the first cloth layer 1, such that the first cloth layer 1 and the second sponge layer 3 are stably bonded by hot pressing. The first cloth layer 1 and the second sponge layer 3 may be completed through a 3D bonding process in other embodiments, thereby facilitating a low-temperature forming. Preferably, the hot melt adhesive film layer 7 is a TPU film, a PA film or an EVA film, the EVA film is used in the present embodiment.

The implementation principle of the cup with hollow lower bowl according to the embodiment of the present application is as follows. Firstly, the second sponge layer 3, the formed net layer 4, the first sponge layer 2 and the second cloth layer 5 are laid in sequence, placed in the lower bowl, then pressed and shaped by a pressing mold, and in turn are cut to obtain the ventilation notches 6, the formed net layer 4 has a width which is half of the width of the second cloth layer 5. The EVA film is placed between the second sponge layer 3 and the first cloth layer 1 and molten by hot pressing, to bond the first cloth layer 1 and the second sponge layer 3, and finally, a clipping is performed.

### Second Embodiment

A one-piece cup with hollow lower bowls, referring to FIG. 8, includes a connection portion and two symmetrically connected sub-cups with hollow lower bowl, the two sub-cups with hollow lower bowl and the connection portion are integrally formed. A support part 9 is connected to a side of the each sub-cup with hollow lower bowl close to the connection portion 8. The support part 9 is provided with a TPU adhesive tape, the TPU adhesive tape is located between the first sponge layer and the first cloth layer. The TPU adhesive tape may be replaced with EVA tape, TPU tape or PA tape with soft texture in other embodiments, to replace the traditional steel ring to support the breast, meanwhile, the soft texture may better fit with the skin.

The implementation principle of the hollow one-piece cup according to the embodiment of the present application is as follows. Firstly, the second sponge layer 3, the formed net layer 4, the first sponge layer 2 and the second cloth layer 5 are laid in sequence and placed in the lower bowl, the formed net layer 4 has a width which is half of the width of the second cloth layer 5. The TPU adhesive tape is placed between the first sponge layer and the first cloth layer, so as to be located at the edge of the lower bowl, and then the whole—13 is pressed and shaped by a one-piece pressing mold, to obtain the one-piece cup. The one-piece cup in turn is cut to obtain the ventilation notches 6. The EVA film is placed between the second sponge layer 3 and the first cloth layer 1 and molten by hot pressing, to bond the first cloth layer 1 and the second sponge layer 3, and finally, a clipping is performed.

The above embodiments are preferred embodiments of the present application, and the protection scope of the present application is not limited thereby, and therefore, equivalent changes made according to the structure, shape and principle of the present application shall be covered by the protection scope of the present application.

### LIST OF REFERENCE SIGNS

1 first cloth layer
2 first sponge layer
3 second sponge layer
4. formed net layer
5 second cloth layer
6 ventilation notch
7. hot melt adhesive film layer
8 connection portion
9 support part

What is claimed is:

1. A cup with hollow lower bowl, comprising a cup body, wherein the cup body is divided into an upper bowl and a lower bowl integrally formed with the upper bowl, a cradle extends from the lower bowl, and a plurality of ventilation notches are defined at intervals at a joint of the lower bowl and the cradle.

2. The cup with hollow lower bowl according to claim 1, wherein each of the plurality of ventilation notches has a width of 4-10 mm.

3. The cup with hollow lower bowl according to claim 1, wherein each of the plurality of ventilation notches is arc-shaped, intermittent arc-shaped, zigzag, waved or rhombic.

4. The cup with hollow lower bowl according to claim 1, wherein each of the upper bowl, the lower bowl and the cradle sequentially comprises a composite layer and a first cloth layer from outside to inside, the composite layer is bonded to the first cloth layer, a side of the composite layer away from the first cloth layer is in contact with an outerwear, a side of the first cloth layer away from the composite layer is in contact with a breast, and the plurality of ventilation notches are defined in the composite layer and penetrate through the composite layer.

5. The cup with hollow lower bowl according to claim 4, wherein the first cloth layer is an elastic cloth layer.

6. The cup with hollow lower bowl according to claim 4, wherein the composite layer sequentially comprises a second cloth layer, a first sponge layer and a second sponge layer, the first sponge layer is connected with the second cloth layer, and the second sponge layer is connected with the first cloth layer.

7. The cup with hollow lower bowl according to claim 6, wherein the composite layer further comprises a formed net layer, and the formed net layer is provided between the first sponge layer and the second sponge layer.

8. The cup with hollow lower bowl according to claim 7, wherein a hot melt adhesive film for bonding is provided between the first cloth layer and the second sponge layer, and the hot melt adhesive film is one of a Thermoplastic Urethane (TPU) film, a polyamide (PA) film or a Polyethylene vinylacetate (EVA) film.

9. A one-piece cup with hollow lower bowl, comprising a connection portion and two sub-cups with hollow lower bowl, wherein the two sub-cups with hollow lower bowl are symmetrically arranged and are integrally formed with the connection portion, and each of the two sub-cups with hollow lower bowl is configured as the cup with hollow lower bowl according to claim 1.
